(19) United States
(12) Patent Application Publication
(10) Pub. No.: US 2026/0265452 A1
(43) Pub. Date: Sep. 10, 2026

(54) High Molecular Weight, Linear Citrate-Based Polymers and Preparations Thereof

(71) Applicant: Acuitive Technologies, Inc., Allendale, NJ (US)

(72) Inventors: Minh-Tuan Richard Tran, Ho-Ho-Kus, NJ (US); Ruqiang Lu, Ramsey, NJ (US)

(73) Assignee: Acutive Technologies, Inc., Allendale, NJ (US)

(21) Appl. No.: 19/557,487

(22) Filed: Mar. 5, 2026

Related U.S. Application Data
(60) Provisional application No. 63/767,347, filed on Mar. 5, 2025.

(51) Int. Cl. C08G 63/06; C08J 3/24

(52) U.S. Cl. CPC C08G 63/06; C08J 3/24; C08J 2367/04

(57) ABSTRACT

High molecular weight linear citrate-based pre-polymers and polymers are provided that provide enhanced mechanical properties and processability for advanced scaffold fabrication techniques. The high molecular weight citrate polymer includes a citrate pre-polymer and optionally a crosslinking group, and generally includes (i) a citrate component, (ii) a diol, and/or (iii) other monomers. Also described herein is a process for preparing linear citrate-based pre-polymers and polymers of the invention.

### CROSS-REFERENCE TO RELATED APPLICATION

The present application claims priority benefit to a US provisional patent application entitled “High Molecular Weight, Linear Citrate-Based Polymers and Preparations Thereof,” which was filed on Mar. 5, 2025, and assigned Ser. No. 63/767,347. The entire content of the foregoing US provisional patent application is incorporated herein by reference.

### FIELD OF THE INVENTION

Provided herein are high molecular weight, linear citrate-based pre-polymers and polymers, which exhibit significantly improved mechanical properties and allow for advanced scaffold fabrication techniques for regenerative engineering applications. Also provided herein are processes for producing the high molecular weight, linear citrate-based pre-polymers disclosed herein.

### BACKGROUND OF THE INVENTION

Polymers can be classified based on their architectural structures into linear, branched, crosslinked, cyclic, star, and grafted types (Pure Appl. Chem. 2022, 94, 1079). These structures are crucial in determining a polymer's solubility, density, and mechanical behavior (Prog. Polym. Sci., 2001, 26, 1233). Controlling these architectural structures provides a strategic approach to tailoring polymer characteristics for different applications.

Poly(diol citrate)s, a class of biodegradable elastomers, have garnered significant attention for their unique properties and versatile applications in regenerative engineering (Adv. Mater. 2024, 36, 2306326, Bioact. Mater., 2023, 19, 511). Specifically, these materials demonstrate desirable biocompatibility characteristics and have antioxidant and anti-inflammatory properties. These materials are typically synthesized through pre-polymerization of citric acid and alcohols to provide the so-called “pre-polymers,” which are subjected to further polymerization to produce crosslinked materials (Adv. Mater. 2006, 16, 511). Regarding functionality, citric acid possesses three carboxylic acid groups and one hydroxyl group, resulting in branched or partially crosslinked pre-polymers due to the similar reactivity of citric acid's three carboxylic acid groups. To ensure solubility and processability of the resulting pre-polymer, typical poly(diol citrate) pre-polymer synthesis reactions are required to be terminated at a low molecular weight, which inherently limits their mechanical properties and further processability (Balani Kantesh et al., Physical, Thermal, and Mechanical Properties of Polymers. Biosurfaces: A Materials Science and Engineering Perspective; Wiley, 2014; pp 329-344.). Previous studies have reported poly(diol citrate) pre-polymers with molecular weights around 1000 Da (Adv. Mater. 2006, 16, 511), limiting their mechanical properties and requirements for scaffold fabrication techniques such as electrospinning and thermally induced phase separation (TIPS). Therefore, there is a need for a process to prepare high-molecular weight citrate polymers that afford improved mechanical properties and processability.

### SUMMARY OF THE INVENTION

Disclosed herein are high molecular weight, linear citrate polymers that address the limitations of low molecular weight branched structures by providing polymer chains with improved mechanical properties and flexibility (Example 2). One embodiment of the invention is a high molecular weight citrate polymer comprising a citrate pre-polymer and, optionally, a crosslinking group. The citrate polymers disclosed herein optionally may utilize a crosslinking group or may be intra-/inter-molecularly crosslinked to adjust the mechanical properties of the polymer. Another embodiment of the present invention is a citrate pre-polymer comprising (i) a citrate component, (ii) a diol, and/or (iii) other monomers.

Another embodiment of the present invention is a process for preparing a high molecular weight, linear citrate pre-polymer comprising the following steps:
(1) contacting citric acid with a suitable protecting group to protect the tertiary carboxylic acid of the citric acid to form a protected citric acid monomer;
(2) contacting the protected citric acid monomer with a diol or another monomer in a polycondensation reaction to form a protected citrate pre-polymer; and
(3) contacting the protected citrate pre-polymer with a suitable reagent to deprotect the tertiary carboxylic acid of the protected citrate pre-polymer to form a linear citrate pre-polymer.

Additional features, functions, and benefits of the disclosed scaffolds will be apparent from the following description.

### BRIEF DESCRIPTION OF THE DRAWINGS

FIG. 1. shows gel permeation chromatography traces of P0, P1, and P2.

FIG. 2. shows representative ¹H NMR spectra of P0, P1 and P2.

FIG. 3. shows comparison of ¹H NMR spectra between P0 and P2.

FIG. 4. shows tensile strain-stress curves of P0 and P2 after crosslinking for one day.

FIG. 5. shows comparison of peak stresses at break between P0 and P2 (n≥3).

FIG. 6. shows comparison of peak elongations at break between P0 and P2 (n≥3).

FIG. 7. shows a scanning electron microscope image of a P2 film prepared through TIPS.

### DETAILED DESCRIPTION

The present disclosure provides an advantageous high molecular weight, linear citrate polymer comprising a citrate pre-polymer and, optionally, a crosslinking group. When present, the crosslinking group is selected from the group consisting of polyols, diamines, polyamines, diisocyanates, and polyisocyanates. However, when the crosslinking group is absent, the citrate pre-polymer may be further crosslinked intra/inter-molecularly. In exemplary embodiments, the high molecular weight citrate polymer of the invention comprises a citrate pre-polymer, which comprises (i) a citrate component, (ii) a diol, and/or (iii) other monomers.

In exemplary embodiments, the citrate component may be selected from the group consisting of citric acid, a salt thereof, and a citric acid derivative (e.g., an ester of citric acid). Additional citric acid derivatives include a citric acid in which one or more of the functional groups have been masked. In a non-limiting example, the tertiary carboxylic acid of citric acid is replaced by a group that can be oxidized to a carboxylic acid (e.g., an alkyne or an aldehyde). Citrate is an inherent molecule in bone anatomy and physiology, playing essential roles in regulating mineral formation and bone metabolism. In biomaterial design, citrate-based polymers present carboxylic acid and hydroxyl functional groups which, can be used for bioceramic interactions, conjugation sites for small molecule attachment, and as crosslinking sites to tune the mechanical and degradation properties of the resulting scaffold.

As described herein, a diol refers to a chemical moiety containing two hydroxyl groups. In exemplary embodiments, the diol is selected from the group consisting of butanediol, hexanediol, octanediol, decanediol, dodecanediol, and polyethylene glycol. In a further exemplary embodiment, the diol is 1,8-octanediol.

In exemplary embodiments, the other monomer is selected from the group consisting of polyols, diamines, polyamines, diisocyanates, and polyisocyanates. As described herein, polyols refer to a chemical moiety containing three or more hydroxyl groups. In exemplary embodiments, a polyol is selected from glycerol, beta-glycerol phosphate, and/or xylitol. As described herein, polyamines refer to a chemical moiety containing three or more amino groups. In exemplary embodiments, a polyamine is selected from tris(2-aminoethyl)amine, polyethylenimine, and/or 1,1,1,-tris(aminomethyl)ethane). As described herein, polyisocyanates refer to a chemical moiety containing three or more isocyanate groups.

In exemplary embodiments, the citrate component, the diol, and/or the other monomer of the citrate pre-polymer are arranged linearly. Herein, the term “linearly” means that the diol and/or other monomers are conjugated to the primary carboxylic acids of the citrate component as shown in structural formula (A):

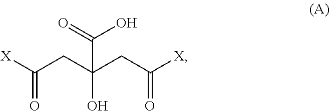

wherein the X represents the linking point of the diol and/or other monomer. As would be understood by one of skill in the art, the pre-polymer may include some amount of branching, e.g. where the diol or other monomer is linked to the tertiary carboxylic acid. In exemplary embodiments, the ratio of linear to branched chains of the citrate polymer is 5:1 or greater, as determined by proton nuclear magnetic resonance (¹H NMR). In a further exemplary embodiment, the ratio of the linear to branched chains of the citrate polymer is 10:1 or greater, 15:1 or greater, or 20:1 or greater.

In an exemplary embodiment, the high molecular weight citrate polymer of the invention exhibits a number average molecular weight of 1.5 kilo Daltons or higher. In a further exemplary embodiment, the high molecular weight citrate polymer of the invention exhibits a number average molecular weight of 2.0 kilo Daltons or higher, 2.5 kilo Daltons or higher, or 3.0 kilo Daltons or higher. In another exemplary embodiment, the high molecular weight citrate polymer of the invention is characterized by a number average molecular weight of 1.5 to 10.0 kilo Daltons, 1.5 to 7.0 kilo Daltons, 2.0 to 7.0 kilo Daltons, 2.0 to 5.0 kilo Daltons, or 2.0 to 4.0 kilo Daltons.

Another exemplary embodiment of the invention is a citrate pre-polymer comprising (i) a citrate component, (ii) a diol, and/or (iii) other monomers. In exemplary embodiments, the citrate component, the diol, and/or the other monomers of the citrate pre-polymer are arranged linearly. In another exemplary embodiment, the ratio of linear to branched chains of the citrate pre-polymer is 5:1 or greater as determined by proton nuclear magnetic resonance (¹H NMR). In a further exemplary embodiment, the ratio of the linear to branched chains of the citrate pre-polymer is 10:1 or greater, 15:1 or greater, or 20:1 or greater. In another exemplary embodiment of the invention, the citrate pre-polymer exhibits a number average molecular weight of 1.0 kilo Daltons or higher. In a further exemplary embodiment, the citrate pre-polymer of the invention exhibits a number average molecular weight of 1.5 kilo Daltons or higher, 2.0 kilo Daltons or higher, or 3.0 kilo Daltons or higher. In another exemplary embodiment, the citrate pre-polymer of the invention is characterized by a number average molecular weight of 1.5 to 30.0 kilo Daltons, 1.5 to 27.0 kilo Daltons, 2.0 to 30.0 kilo Daltons, or 2.0 to 27.0 kilo Daltons.

Also included in the invention is a process for preparing a linear citrate pre-polymer comprising the following steps:
(1) contacting citric acid with a suitable protecting group (PG) to protect the tertiary carboxylic acid of the citric acid to form a protected citric acid monomer of structural formula (I):

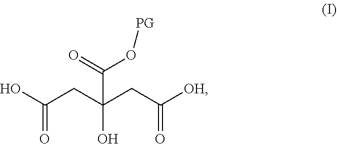

(2) contacting the protected citric acid monomer of structural formula (I) with a diol or another monomer in a polycondensation reaction to form a protected, linear citrate pre-polymer; and
(3) contacting the protected citrate pre-polymer with a suitable reagent to deprotect the tertiary carboxylic acid of the protected citrate pre-polymer to form a linear citrate pre-polymer.

As described herein and as would be understood by those of skill in the art, the citric acid in the described process may be interchanged with an appropriate citrate salt or a citric acid derivative thereof.

The polycondensation reaction described herein refers to the polymerization reaction between the citric acid and a diol and/or other monomer. In exemplary embodiments, the diol is selected from the group consisting of butanediol, hexanediol, octanediol, decanediol, dodecanediol, or polyethylene glycerol. In a further exemplary embodiment, the diol is 1,8-octanediol. In another exemplary embodiment, the other monomer is selected from the group consisting of polyols, diamines, polyamines, diisocyanates, and polyisocyanates.

Further, it has been discovered that the polycondensation reaction conditions can provide polymers with different molecular weights. With a consistent reaction setup, the reaction time is correlated to the viscosity of the reaction, which is suggestive of the molecular weight of the resulting polymer. In an exemplary embodiment, the polycondensation reaction can be terminated at different viscosities to control the molecular weight of the protected, linear citrate pre-polymer. In another exemplary embodiment, the polycondensation reaction can be terminated at pre-determined times to control the molecular weight of the protected, linear citrate pre-polymer.

In another exemplary embodiment, the polycondensation reaction may be performed at elevated temperatures. Elevated temperatures, as described herein, are higher than the melting point of the monomers but lower than the decomposition temperature of the monomer or pre-polymer. In some embodiments, elevated temperatures are 50° C. or greater, 60° C. or greater, 70° C. or greater, 80° C. or greater, 90° C. or greater, or 100° C. or greater. In an exemplary embodiment of the invention, the polycondensation reaction may be carried out at 130 to 160° C. In a further exemplary embodiment, the polycondensation reaction is carried out at 135° C. or greater.

In a further exemplary embodiment, the reaction may be performed in the presence or absence of a catalyst. A catalyst, as described herein, refers to a chemical reagent that accelerates the reaction rate of the polycondensation reaction. As would be understood by one skilled in the art, a suitable catalyst can vary depending on the monomers of the polycondensation reaction. In exemplary embodiments, the catalyst is an acid catalyst. In a further exemplary embodiment, the catalyst is p-toluenesulfonic acid.

Herein, a suitable protecting group is intended to refer to any chemical moiety that would protect the tertiary carboxylic acid of the citric acid from undergoing a reaction with the diol or other monomer during the subsequent polycondensation reaction. In exemplary embodiments, the suitable protecting group is an ester protecting group, a thioester protecting group, an oxazoline protecting group, or a chemical moiety which links the tertiary carboxylic acid with the tertiary hydroxyl group of the citric acid to form a heterocycle. In further exemplary embodiments, the suitable protecting group is selected from the group comprising benzyl ester, tert-butyl ester, S-t-butyl ester, and 2-alkyl-1,3-oxazoline. In a further exemplary embodiment, the suitable protecting group is a benzyl ester.

In an exemplary embodiment, step (1) of the process comprises:
a) contacting the citric acid with paraformaldehyde to form a compound represented by structural formula (Ia):

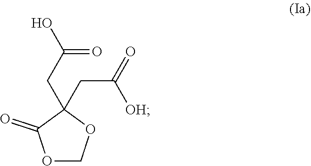 [SMILES: O=C(O)CC1(CC(=O)O)OCOC1=O]

and
b) contacting the compound represented by structural formula (Ia) with benzyl alcohol to form a compound represented by structural formula (Ib):

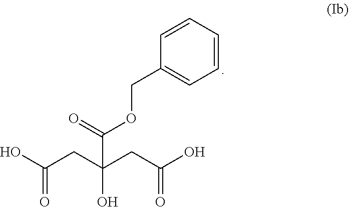 [SMILES: O=C(O)CC(O)(CC(=O)O)C(=O)OCc1ccccc1]

In another exemplary embodiment, step (2) of the process comprises contacting a compound of structural formula (Ib):

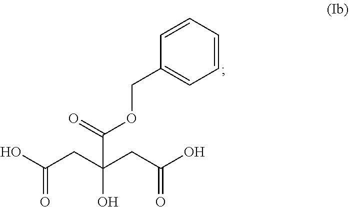 [SMILES: O=C(O)CC(O)(CC(=O)O)C(=O)OCc1ccccc1]

with 1,8-octanediol and catalytic p-toluene sulfonic acid in a polycondensation reaction to form a protected citrate pre-polymer having a subunit represented by structural formula (II):

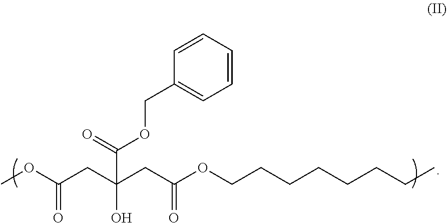

In another exemplary embodiment, step (3) of the process comprises contacting a protected citrate pre-polymer having a subunit represented by structural formula (II):

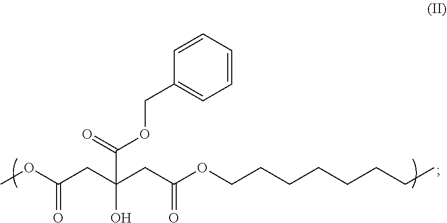

with hydrogen gas and palladium on carbon to form a linear citrate pre-polymer having a subunit represented by structural formula (III):

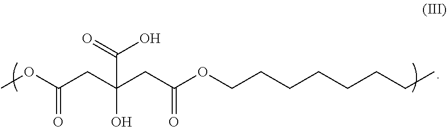

In another embodiment, the linear citrate pre-polymer may be subjected to further crosslinking. In one embodiment, further crosslinking of the linear citrate pre-polymer may involve an additional crosslinking group. In another embodiment, further crosslinking can be intra/inter-molecular crosslinking between the unreacted functional groups (e.g. carboxylic acid groups, hydroxyl groups, amine groups, etc.) of the linear citrate pre-polymer. In exemplary embodiments, the crosslinking group is selected from the group consisting of polyols, diamines, polyamines, diisocyanates and polyisocyanates. In another exemplary embodiment, the intra/inter-molecular crosslinking may occur at elevated temperatures.

In another embodiment, the pre-polymers of the present disclosure may be used to form porous films. The porous films may be prepared by any means known to one of skill in the art. In exemplary embodiments, the pre-polymers of the invention may be formed into a porous film through thermally induced phase separation (TIPS) or gas foaming. In an exemplary embodiment, the pre-polymers of the invention are formed into a porous film using TIPS.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure but that the present disclosure will include all embodiments falling within the scope of the claims.

### EXEMPLIFICATION

### Example 1: Preparation of Poly(Diol Citrate) Polymers (P0-P2)

### Preparation of a Control Branched Polymer (P0)

P0 was synthesized according to the known procedure (Adv. Mater. 2004, 16, 511).

### Preparation of a Linear Poly(Octamethylene Citrate) Polymer (P1 and P2)

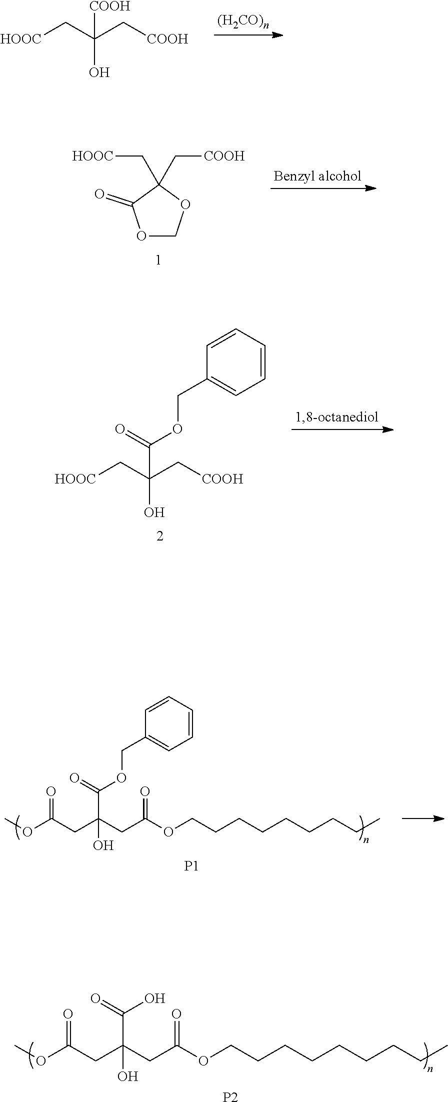

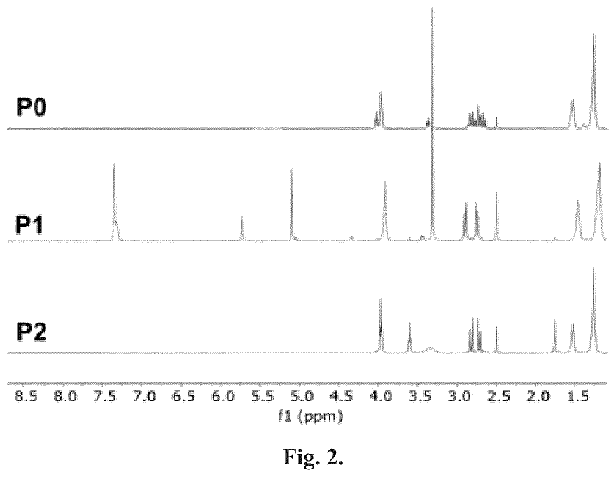

The tertiary carboxylic acid group of citric acid was first protected with benzyl ester to afford compound 2 following established procedures (See Chem. Pharm. Bull. 1999, 47, 1284 and J. Org. Chem. 1983, 48, 24). Polycondensation of the protected citric acid 2 with 1,8-octanediol in a 1:1 molar ratio at 135° C. yielded a linear protected pre-polymer with a number average molecular weight (Mₙ) of 13.1 kDa (P1). The resulting pre-polymer is highly soluble in various solvents such as dichloromethane, tetrahydrofuran, and ethyl acetate. Subsequent deprotection resulted in linear poly(octamethylene citrate) (POC) (P2) with a molecular weight of 3.77 kDa consistent with the theoretical value calculated by subtracting the molecular weight of the removed benzyl ester moiety from the Mₙ of P1. The successful deprotection of benzyl ester was confirmed by ¹H NMR of P2, which showed no aromatic peaks attributed to the benzyl ester (chemical shift at 7.35 ppm) (FIG. 2).

Molecular weight control of P1 can be achieved by adjusting the reaction time of the polycondensation reaction. This was demonstrated by terminating the polycondensation reaction at a pre-determined time. As would be understood by one of skill in the art, with a consistent reaction setup, the reaction time is correlated to the viscosity of the reaction, which is suggestive of the molecular weight of resulting polymer. As an example, for the longest reaction time, the reaction was terminated when the stir bar did not freely move and afforded a pre-polymer P1′. P1′ exhibited a two-fold higher number average molecular weight (Mₙ) of 26.2 kDa compared to P1. Note that extending the reaction time resulted in a broader molecular weight distribution (PDI=5.37 for P1′) and reduced pre-polymer solubility.

### Determination of Architectural Structure of P0 and P2

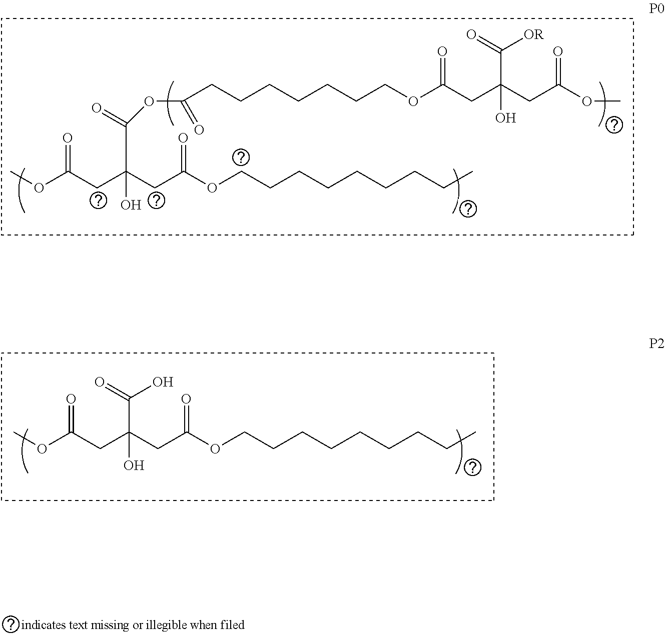

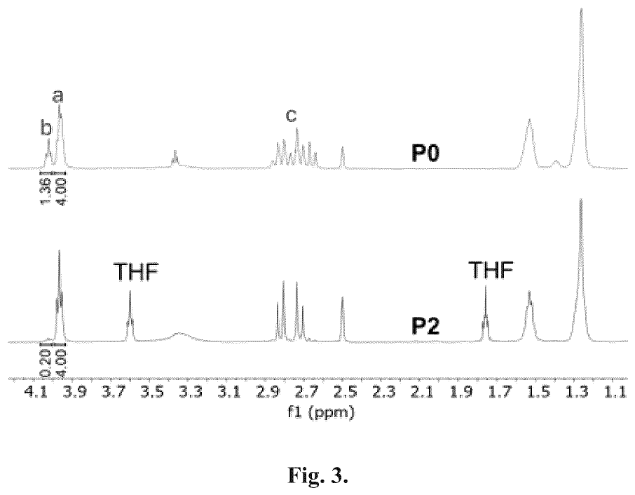

For the control P0, the peaks at 4.02 and 3.97 ppm were assigned to protons a and b, respectively. The ratio of peak b area [b] to peak a area [a] was used to quantify the degree of branching. As shown in FIG. 3, the [b]/[a] ratio for P0 was 1.36/4.00, significantly higher than that of P2 ([b]/[a]=0.20/4.00), indicating a much more linear structure for P2. The minor branching observed in P2 may be attributed to esterification during the workup process or transesterification during the polycondensation reaction.

### Example 2: Characteristics of Linear Poly(Diol Citrate) Polymers of the Invention

### Number Average Molecular Weight (Mₙ)

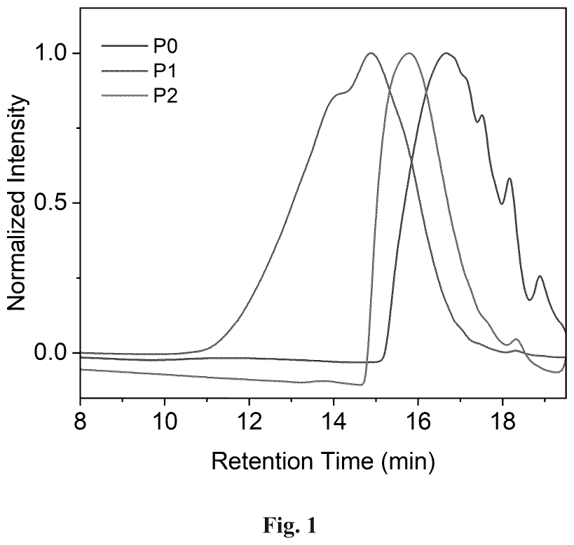

Protected linear poly(octamethylene citrate) (P1) and deprotected linear poly(octamethylene citrate) (P2) were prepared according to Example 1 above. For reference, a control branched POC (P0) was also synthesized using equal molar amounts of citric acid and 1,8-octanediol according to Example 1 above. As shown in FIG. 1 and Table 1, the linear POC of the present invention exhibited a molecular weight of 3.77 kDa, which is more than three times higher than that of the control branched POC (P0). Polymers with larger molecular weights generally possess improved mechanical properties due to increased chain entanglement.

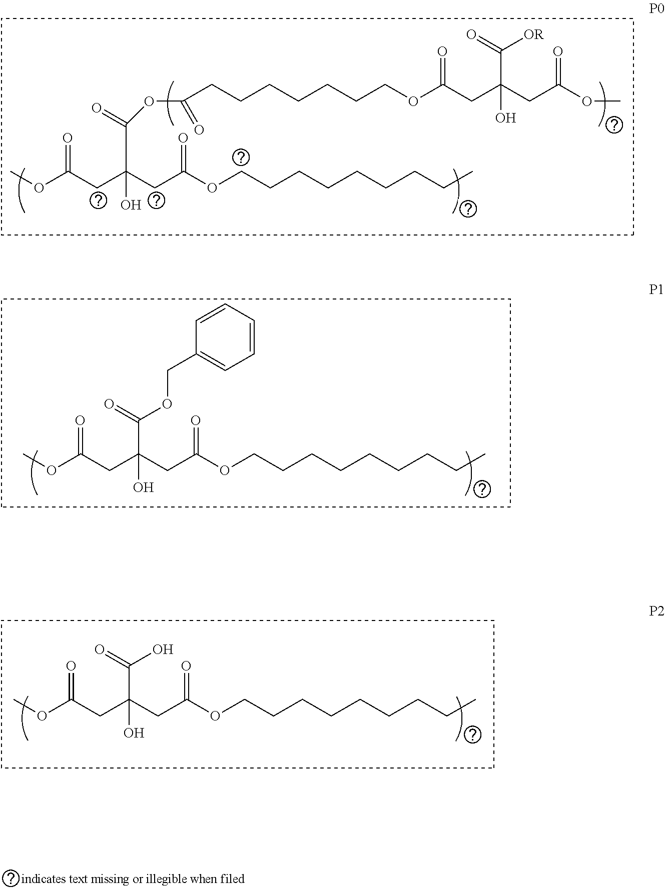

TABLE 1
Summary of molecular weights.

| | Mₙ (kDa) | Polydisperse index (PDI) |
|---|---|---|
| P0 | 1.12 | 2.28 |
| P1 | 13.1 | 4.27 |
| P2 | 3.77 | 1.62 |

### Peak Stress and Stretch Testing

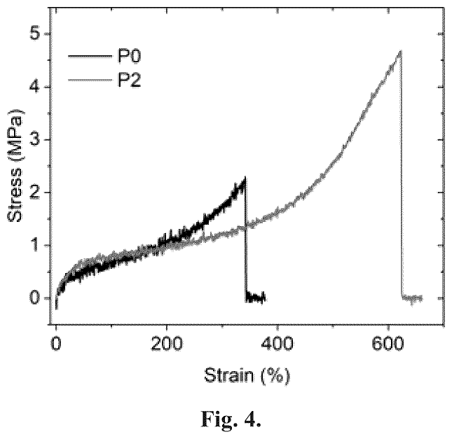

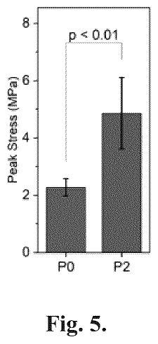

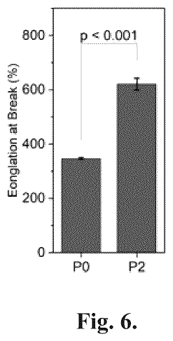

Polymers P0 and P2 were dried and crosslinked at 83° C. for one day. The resulting polymers were then subjected to tensile testing. As shown in FIGS. 4-6, P0 demonstrated peak stress and elongation at break of 2.28 MPa and 346%, respectively, while P2 exhibited a peak stress and elongation at break of 4.86 MPa and 621%, respectively, significantly surpassing the values of P0. This improvement in mechanical performance highlights the importance of increasing molecular weight of the polymer.

### Example 3: Preparation of Porous Scaffolds Using Polymers of the Invention

Typically, poly(octamethylene citrate) (POC) pre-polymers have been limited in their ability to form porous films using thermally induce phase separation (TIPS) techniques. This is largely a result of the low molecular weight of the POC pre-polymers. To overcome these limitations, urethane-doping is necessary to achieve these properties, which complicates the material composition (Biomaterials, 2008, 29, 4637).

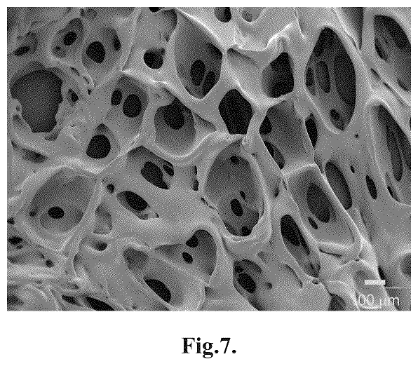

However, the POC pre-polymers of the invention (P2) have overcome this limitation and exhibited the capacity to form porous scaffolds via various known processes, for example, TIPS or gas foaming. FIG. 7 shows a porous scaffold prepared through a TIPS process using the pre-polymer (P2) of the disclosure.

Of note, the high molecular weight citrate polymer techniques/modalities disclosed herein may be applied to other citrate-based formulations, including, without limitation, the citrate-based formulations disclosed in U.S. Pat. Nos. 7,923,486, 8,530,611, 8,574,311, 9,642,933, and 10,106,647, the contents of which are incorporated herein by reference, and composites formed therefrom, e.g., polymer-bioceramic mixtures.

What is claimed is:

1. A high molecular weight citrate polymer comprising a citrate pre-polymer and optionally a crosslinking group, wherein the citrate pre-polymer comprises:
(i) a citrate component,
(ii) a diol, and/or
(iii) other monomers.

2. The high molecular weight citrate polymer of claim 1, wherein the citrate component is selected from citric acid, a salt thereof, and a citric acid derivative.

3. The high molecular weight citrate polymer of claim 1, wherein the diol is selected from the group consisting of butanediol, hexanediol, octanediol, decanediol, dodecanediol, and polyethylene glycol.

4. The high molecular weight citrate polymer of claim 1, wherein the other monomers are selected from the group consisting of polyols, diamines, polyamines, diisocyanates, and polyisocyanates.

5. The high molecular weight citrate polymer of claim 1, wherein the citrate component, the diol, and/or the other monomers are arranged linearly.

6. The high molecular weight citrate polymer of claim 1, wherein the average molecular weight is 1.0 kilo Daltons or greater.

7. The high molecular weight citrate polymer of claim 1, wherein the crosslinking group is absent.

8. The high molecular weight citrate polymer of claim 1, wherein the citrate pre-polymer is further intra-molecularly or inter-molecularly cross-linked.

9. The high molecular weight citrate polymer of claim 1, wherein the crosslinking group is selected from the group consisting of polyols, diamines, polyamines, diisocyanates and polyisocyanates.

10. A linear citrate pre-polymer comprising:
(i) a citrate component,
(ii) a diol, and/or
(iii) other monomers.

11. The linear citrate pre-polymer of claim 10, wherein the citrate component is selected from citric acid, a salt thereof, and a citric acid derivative.

12. The linear citrate pre-polymer of claim 10, wherein the diol is selected from the group consisting of butanediol, hexanediol, octanediol, decanediol, dodecanediol, or polyethylene glycerol.

13. The linear citrate pre-polymer of claim 10, wherein the other monomers is selected from the group consisting of polyols, diamines, polyamines, diisocyanates and polyisocyanates.

14. A process for preparing a linear citrate pre-polymer comprising the following steps:
(1) contacting citric acid with a suitable protecting group (PG) to protect the tertiary carboxylic acid of the citric acid to form a protected citric acid monomer of structural formula (I): 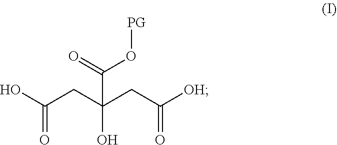
(2) contacting the protected citric acid monomer of structural formula (I) with a diol or other monomer in a polycondensation reaction to form a protected, linear citrate pre-polymer; and
(3) contacting the protected citrate pre-polymer with a suitable reagent to deprotect the tertiary carboxylic acid of the protected citrate pre-polymer to form a linear citrate pre-polymer.

15. The process of claim 14, wherein the suitable protecting group is selected from the group consisting of ester protecting groups, thioester protecting groups and oxazoline protecting groups such as benzyl ester, tert-butyl ester, S-t-butyl ester, and 2-alkyl-1,3-oxazoline.

16. The process of claim 14, wherein the suitable protecting group is a benzyl ester.

17. The process of claim 14, wherein the diol is selected from the group consisting of butanediol, hexanediol, octanediol, decanediol, dodecanediol, or polyethylene glycerol.

18. The process of claim 14, wherein the diol is 1,8-octanediol.

19. The process of claim 14, wherein step (1) comprises:
a) contacting the citric acid with paraformaldehyde to form a compound represented by structural formula (Ia): 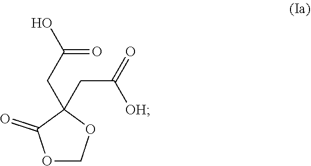 [SMILES: O=C(O)CC1(CC(=O)O)OCOC1=O]
and
b) contacting the compound represented by structural formula (Ia) with benzyl alcohol to form a compound represented by structural formula (Ib):

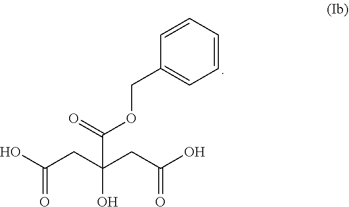 [SMILES: O=C(O)CC(O)(CC(=O)O)C(=O)OCc1ccccc1]

20. The process of claim 14, wherein step (2) comprises contacting a compound of structural formula (Ib): 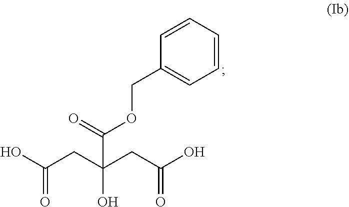 [SMILES: O=C(O)CC(O)(CC(=O)O)C(=O)OCc1ccccc1]
with 1,8-octanediol and catalytic p-toluene sulfonic acid in a polycondensation reaction to form a protected citrate pre-polymer having a subunit represented by structural formula (II):

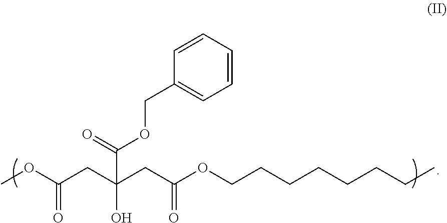

21. The process of claim 14, wherein step (3) comprises contacting a protected citrate pre-polymer having a subunit represented by structural formula (II): 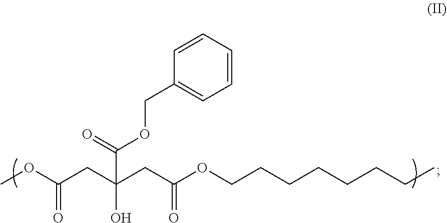
with hydrogen gas and palladium on carbon to form a linear citrate pre-polymer having a subunit represented by structural formula (III):

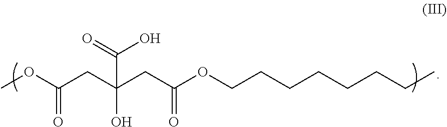

22. The process of claim 14, wherein the molecular weight of the linear citrate pre-polymer is controlled by terminating the polycondensation reaction at a pre-determined time.
